(19) United States
(12) Patent Application Publication
(10) Pub. No.: US 2025/0021666 A1
(43) Pub. Date: Jan. 16, 2025

(54) CRYPTOGRAPHIC AGILITY FOR PRIVACY PRESERVATION OF DATA IN USE WITHIN AGGREGATION FUNCTIONS

(71) Applicant: VMware LLC, Palo Alto, CA (US)

(72) Inventors: Daniel James BEVERIDGE, Valrico, FL (US); David OTT, Chandler, AZ (US); Martin Patrick STACK, Folsom, CA (US); Sean HUNTLEY, NSW (AU)

(21) Appl. No.: 18/351,535

(22) Filed: Jul. 13, 2023

(51) Int. Cl. G06F 21/60

(52) U.S. Cl. CPC G06F 21/602

(57) ABSTRACT

The disclosure provides an approach for cryptographic agility for privacy-preserving data aggregation. Embodiments include receiving a request for dynamic cryptographic technique selection related to a data aggregation process, wherein the data aggregation process is to involve an aggregator device performing one or more computations on data that is to be provided from multiple endpoints. Embodiments include selecting a cryptographic technique based on contextual information related the request, wherein the contextual information comprises one or more of: one or more types of mathematical operations that are to be performed by the aggregator device on the data that is to be provided from the multiple endpoints during the data aggregation process; or an indication of whether the aggregator device is associated with a confidential computing component. Embodiments include providing a response based on the selecting of the cryptographic technique.

### BACKGROUND

Cryptography generally involves techniques for protecting data from unauthorized access. For example, data transmitted over a network may be encrypted in order to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Key size affects the strength of a cryptographic technique and is a configuration parameter. Having more bits in a key size results in more computation, but a larger space of possible mappings from cleartext to ciphertext, which is a quality makes it harder for an adversary to guess a key having a larger number of bits.

Ciphertext size refers to the number of bits in the output from a cryptographic algorithm, which may be the same as the number of bits of the input or may include padding to produce a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Data aggregation generally involves receiving multiple items of data, such as from different data sources, and performing one or more computations in order to produce an aggregated result based on the multiple items of data. On example of data aggregation is federated learning, which generally refers to privacy-preserving techniques in which a machine learning model is trained across multiple decentralized edge devices or servers that hold local data without exchanging the local data between the edge devices. In one example, edge devices perform local training and provide training results to an aggregator device, which aggregates the training results among the multiple edge devices to update a centralized model, which can then be re-distributed to the edge devices for subsequent training and/or use. Cryptography may be used in a data aggregation process (e.g., federated learning) in order to protect data during transmission, such as between edge devices and an aggregator device. For example, edge devices may encrypt local data before sending it to the aggregator device, such as sharing an encryption key with the aggregator device via a separate secure channel, and the aggregator device may encrypt a final result of aggregation (e.g., a centralized model) in a similar manner before sending it back to the edge devices.

While existing data aggregation techniques may protect data during transmission between endpoints, these techniques require the endpoints to be trusted with access to the unencrypted data. For example, an aggregator device must be trusted to access the local data from all participating edge devices. Furthermore, existing data aggregation techniques rely on fixed cryptographic techniques, such as those that the software applications performing the operations related to data aggregation are configured to support, and these fixed cryptographic techniques may not be optimal for the varying contexts in which data aggregation techniques are performed.

As such, there is a need for improved techniques for secure and performant data aggregation.

### BRIEF DESCRIPTION OF THE DRAWINGS

FIG. 1 is an illustration of example computing components related to confidential computing and homomorphic encryption for privacy-preserving data aggregation, according to embodiments of the present disclosure.

FIG. 2 is an illustration of an example related to dynamic cryptographic technique selection, such as between confidential computing and homomorphic encryption, for privacy-preserving data aggregation.

FIG. 3 depicts an example of tagging cryptographic techniques based on parameters, including confidential computing and homomorphic encryption related parameters.

FIG. 4 is a diagram depicting an example related to dynamic cryptographic technique selection for privacy-preserving data aggregation.

FIG. 5 depicts example operations for dynamic cryptographic technique selection for privacy-preserving data aggregation according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to cryptographic agility for privacy preservation of data in use within aggregation functions. In particular, the present disclosure provides an approach for dynamically selecting and configuring cryptographic techniques, such as confidential computing techniques and/or homomorphic encryption techniques, based on parameters related to a privacy-preserving data aggregation process.

Cryptographic agility generally refers to techniques for dynamic selection and/or configuration of cryptographic algorithms. According to certain embodiments, logic related to selection and/or configuration of cryptographic algorithms is decoupled from the applications that utilize cryptographic functionality, and is implemented in one or more separate components. Thus, rather than an application directly calling a cryptographic library to perform cryptographic functionality, the application may call generic cryptographic functions provided by a separate cryptographic agility system, and the cryptographic agility system may then select and/or configure cryptographic algorithms, such as based on contextual information and/or policies. For instance, the cryptographic agility system may dynamically determine which libraries, algorithms, configuration values, and/or the like to select based on factors such as the type of data being encrypted, the type of application requesting encryption, the network environment(s) in which the data is to be sent, a destination to which encrypted data is to be sent, geographic locations associated with a source and/or destination of the data, attributes of users associated with the encryption, regulatory environments related to the encryption, network conditions, resource availability, performance constraints, device capabilities, and/or the like.

According to embodiments of the present disclosure, cryptographic techniques are dynamically selected based on attributes related to a privacy-preserving data aggregation process (e.g., a federated learning process), such as whether an aggregator device is trusted to access the data being aggregated, whether the aggregator device has one or more types of hardware required for confidential computing, based on the mathematical operations to be performed by an aggregator device in order to produce an aggregated result (e.g., in the case of homomorphic encryption), resource constraints, and/or the like.

Examples of privacy-preserving data aggregation processes include federated learning, industrial information aggregation (e.g., processes in which data from multiple endpoints is aggregated without any result of the aggregation being sent back to the endpoints), and/or the like. Embodiments of the present disclosure may be employed for any type of process in which data from multiple endpoints is aggregated, whether federated learning, information aggregation in which results of aggregation are not sent back to the endpoints, or another type of data aggregation.

An aggregator device may in some cases not be trusted with access to data being aggregated. For example, if local model gradients, parameter data, and/or participant data are sent from a plurality of endpoints to an aggregator device for aggregation, there is a possibility that sensitive local data could be reconstructed from these data points. Furthermore, such data may be vulnerable to side channel attacks or insider attacks at the aggregator device. A compromised operating system or other software associated with the aggregator device could also gain access to sensitive data while it is being processed at the aggregator device.

In a particular example, different types of confidential computing techniques and/or homomorphic encryption algorithms may be dynamically selected for privacy-preserving data aggregation based on a variety of factors. For example, while many cryptographic techniques involve encrypting data at the source and decrypting the data at the destination in order to protect the privacy of the data during transmission, confidential computing and homomorphic encryption techniques provide an additional benefit of preserving the privacy of the data while it is processed at the destination (e.g., data in use), thereby allowing for arrangements in which the data is never decrypted at the destination (e.g., except within a confidential computing environment in the case of confidential computing).

Confidential computing generally refers to computing techniques that isolate sensitive data in a protected processor enclave during processing. The enclave may be referred to as a trusted execution environment (TEE). The contents of the enclave, including the data that is processed and the logic used to process the data, are accessible only to authorized programming code, and are invisible and in accessible to any other components outside of the enclave. Such an enclave or TEE may be an example of a confidential computing component as discussed herein. Confidential computing provides many advantages, such as the ability to perform computations on sensitive data without exposing the sensitive data to any entities outside of the secure enclave, including not exposing the sensitive data to any other components of the device on which the secure enclave is located and/or to an entity that operates such a device (e.g., a cloud provider). Furthermore, confidential computing is generally resource-efficient with respect to processor, memory, and network resources. However, confidential computing requires specialized hardware (e.g., a secure processor enclave), and so cannot be performed in the absence of such hardware.

According to techniques described herein, selecting a confidential computing technique for use in a secure aggregation process allows an aggregator device to perform computations on encrypted data received from multiple endpoints (e.g., edge devices) within a secure enclave that decrypts the data without the aggregator device otherwise being granted access to the unencrypted data, and thereby preserving the privacy of the underlying data, while producing an encrypted aggregated result that can be decrypted by the endpoints. For example, if local models at multiple edge devices are being trained based on local data that is sensitive (e.g., medical information, personally identifiable information (PII), classified information, private user data, and/or the like) and yet there is a desire to train a global model that is not biased by the potentially unique attributes of the local data, the edge devices may encrypt their local model parameters (e.g., gradients) using some form of encryption, confidentially share an encryption key directly with the secure enclave via a secure channel, and then send the encrypted local model parameters to the aggregator device for aggregation within the secure enclave in a privacy-preserving manner. The aggregator device may perform computations on the encrypted local model parameters received from the edge devices within the secure enclave (e.g., the secure enclave may decrypt the parameters using the received key(s), perform the computations, and then encrypt the result, such as using the received key(s)) in order to determine global model parameters (which will remain encrypted outside of the secure enclave). The global model parameters, when sent back to the edge devices, can be decrypted (e.g., using the same encryption key or keys used to encrypt the local model parameters) in order to produce an unencrypted global model at the edge devices.

Homomorphic encryption generally refers to encryption techniques that allow one or more types of mathematical operations to be performed on encrypted data without decryption and without exposing the underlying data. With homomorphic encryption, the result of performing a mathematical operation on the encrypted data remains in an encrypted form which, when decrypted, results in an output that is identical to that produced had the mathematical operation been performed on the unencrypted data. Homomorphic encryption techniques can be resource-intensive with respect to processor, memory, and network resources, but do not generally require specialized hardware.

According to techniques described herein, selecting a homomorphic encryption technique for use in a secure aggregation process allows an aggregator device to perform computations on encrypted data received from multiple endpoints (e.g., edge devices) without the aggregator device being granted access to the unencrypted data, and thereby preserving the privacy of the underlying data, while producing an aggregated result that can be decrypted by the endpoints as if the computations had been performed on the unencrypted data. For example, if local models at multiple edge devices are being trained based on local data that is sensitive and yet there is a desire to train a global model that is not biased by the potentially unique attributes of the local data, the edge devices may encrypt their local model parameters (e.g., gradients) using homomorphic encryption and then send the encrypted local model parameters to the aggregator device for aggregation in a privacy-preserving manner. The aggregator device may perform computations on the encrypted local model parameters received from the edge devices in order to determine global model parameters (which will remain encrypted). The global model parameters, when sent back to the edge devices, can be decrypted using the same homomorphic encryption key or keys used to encrypt the local model parameters in order to produce an unencrypted global model at the edge devices.

There are different types of homomorphic encryption algorithms that support different types of mathematical operations. For example, some homomorphic encryption algorithms only allow addition to be performed on the encrypted data, some homomorphic encryption algorithms allow multiplication to be performed on the encrypted data, and some homomorphic algorithms are “fully homomorphic” such that they support the full range of possible mathematical operations on the encrypted data. Generally, a fully homomorphic encryption algorithm allows the evaluation of arbitrary circuits composed of multiple types of gates of unbounded depth and is the strongest notion of homomorphic encryption.

Different homomorphic encryption algorithms have different levels of security and/or vary in the amount of computing resources (e.g., processing, memory, and/or network resources) that are utilized during encryption, decryption, and transmission of encrypted data. For example, fully homomorphic encryption algorithms are generally resource-intensive, and so cannot be used on devices with limited available computing resources. Furthermore, there are many different types of fully homomorphic encryption techniques and many different types of partially homomorphic encryption techniques, including many different potential configurations of many different potential algorithms associated with many different potential libraries, and selection among these different techniques may be based on a variety of factors, such as the mathematical operations to be performed, the resource-efficiency of these techniques, the level of security of these techniques, attacks protected against, device limitations, and/or the like. When determining whether to select a fully homomorphic encryption technique or a partially homomorphic encryption technique, a cryptographic agility system as described herein may consider the cost in computing resources given the nature of the aggregation to be performed, the availability of acceleration hardware that could be utilized for particular types of homomorphic encryption (e.g., fully homomorphic encryption), device hardware provisioning, and/or the like.

Additionally, there may be many different types of confidential computing, including different technologies (e.g., different secure enclaves), different libraries, different confidential computing based aggregation libraries, and/or the like.

Thus, according to embodiments of the present disclosure, different types of privacy-preserving cryptographic techniques, including but not limited to confidential computing techniques and homomorphic encryption techniques (e.g., including many different algorithms/technologies with many different configurations), may be dynamically selected for different situations based on, for example, whether specialized hardware required for certain confidential computing techniques is available, the resource constraints of the aggregator device, which mathematical operations are to be performed by the aggregator device, and/or the like. For example, when determining whether to select a confidential computing technique, a cryptographic agility system as described herein may consider the availability of the required technology on the platform (e.g., whether a secure enclave is present), the amounts of resources available (e.g., memory size and computation capacity), whether attestation can successfully be performed (e.g., if the aggregator device has the capability to attest to the accuracy and confidential nature of computations that are performed), availability of confidential computing libraries and secure aggregation implementations, and/or the like.

In some cases, a mix of confidential computing and homomorphic encryption may be selected for handling a particular cryptographic request, such as using one or more confidential computing techniques for some operations and using one or more homomorphic encryption techniques for other operations.

The cryptographic agility system may, for instance, determine estimated processing requirements, memory requirements, device requirements, and the like for different cryptographic techniques, such as based on tags associated with the cryptographic techniques, and may use this information in conjunction with information about available processing resources, available memory resources, device capabilities, and the like for devices that are to perform cryptographic operations in order to dynamically select cryptographic techniques for particular circumstances, such as for particular data aggregation processes.

In some embodiments, one or more policies may specify when certain types of techniques should be selected. For example, a policy may specify that a confidential computing technique should always be selected rather than a homomorphic encryption technique (e.g., due to the relatively lower computing resource utilization involved) if the specialized hardware needed for such a technique is available. In some cases, if specialized hardware is not available (and/or under one or more other conditions), a homomorphic encryption technique may be selected based on one or more factors. For instance, if the aggregator device only needs to perform addition then it may not be necessary to utilize a homomorphic encryption technique that supports more complex types of mathematical operations and that utilizes a higher amount of computing resources, and so a homomorphic encryption algorithm that only supports addition may be selected.

In some embodiments, a variety of additional factors may also be used to dynamically select an encryption algorithm for a privacy-preserving data aggregation process. For example, policies may be defined by users (e.g., administrators), and may specify rules for selecting and/or configuring (e.g., setting particular parameters) cryptographic techniques. Policies may specify, for example, conditions under which cryptographic techniques must comply with one or more standards (e.g., Federal Information Processing Standards or FIPS), when a quantum-safe cryptographic technique must be selected, how to select among different quantum-safe cryptographic techniques, conditions for selecting key sizes (e.g., based on a desired level of security or based on different algorithm standards such as particular elliptical curves), and/or the like. In one example, cryptographic techniques (e.g., algorithms and/or configurations of algorithms) are tagged with different levels of security (e.g., rated from 0-10), and a policy associated with an application may specify that all data that is to be transmitted from the application to a destination in a given type of networking environment, such as a public network, is to be encrypted using a high-security algorithm (e.g., rated 8 or higher). Thus, if the application calls a function provided by the cryptographic agility system to encrypt an item of data for a data aggregation process, and contextual information indicates that the data is to be transmitted to a device (e.g., an aggregator device) on a public network, then the cryptographic agility system, in certain embodiments, will select a cryptographic technique tagged as a high-security technique, such as with a security rating of 8 or higher, such as in addition to being a confidential computing technique or a homomorphic encryption algorithm that supports the required mathematical operations. In another example, a policy may specify that confidential computing is to be used for all cryptographic requests related to privacy-preserving data aggregation that are associated with a particular geographic region, organization, and/or locality and/or that homomorphic encryption is to be used for all cryptographic requests related to privacy-preserving data aggregation that are associated with another particular geographic region, organization, and/or locality. This may be due to differing preferences with respect to confidential computing and/or homomorphic encryption associated with different regions, countries, organizations, and/or the like. In another example, cryptographic techniques are tagged with indications of whether they comply with particular standards, and a policy may specify that all data associated with a particular application or for a particular purpose is to be encrypted with a cryptographic technique that complies with a particular standard (e.g., FIPS). In such an example, if an application calls a function provided by the cryptographic agility system to encrypt an item of data, and contextual information indicates that the data relates to the particular purpose or that the application is the particular application, then the cryptographic agility system, in certain embodiments, will select a cryptographic algorithm tagged as being compliant with the particular standard.

In yet another example, cryptographic techniques are tagged with indications of whether they have certain characteristics or support certain configurations, and a policy may specify that all data that is to be transmitted as part of a data aggregation process is to be encrypted using a cryptographic technique that does or does not have one or more particular characteristics or configurations. Thus, if the cryptographic agility system receives a request to encrypt an item of data for a data aggregation process, then the cryptographic agility system, in certain embodiments, will select a cryptographic algorithm tagged with indications that the cryptographic algorithm does or does not have the one or more particular characteristics or configurations indicated in the policy. Accordingly, an organization or user may specify policies based on their own preferences of which characteristics or configurations of cryptographic techniques are most secure or desirable and/or based on specific compliance requirements.

By decoupling cryptographic logic from applications that rely on cryptographic functionality for performing privacy-preserving data aggregation operations, cryptographic agility techniques described herein provide flexibility and extensibility, thus allowing cryptographic techniques to be continually updated, changed, and otherwise configured without requiring modifications to the applications themselves, such as allowing for the utilization of new types of confidential computing and/or homomorphic encryption that are not natively supported by the application. Accordingly, changing circumstances may be addressed in a dynamic and efficient manner, and computing security may thereby be improved. For example, endpoints may utilize techniques described herein to dynamically select privacy-preserving cryptographic techniques for use in encrypting local parameters to send to an aggregator device, and the aggregator device may utilize techniques described herein to encrypt a global model trained based on aggregating the received local parameters from the endpoints. In some embodiments, the aggregator device may not need to encrypt the global model, as it may have been generated based on homomorphically encrypted local parameters, and thus the global model parameters may remain encrypted until they are unencrypted by the endpoints upon receipt.

According to embodiments of the present disclosure, cryptographic techniques are dynamically selected and/or configured for use in privacy-preserving data aggregation operations based on additional factors such as network and/or resource constraints. In some cases, a cryptographic algorithm may be referred to as a “cipher”. Cryptographic algorithms have varying resource requirements, such as different memory, processing, and/or communication resource requirements. For example, some algorithms are more computationally-intensive than others and some algorithms involve storage and/or transmission of larger amounts of data than others. For example, algorithms involving larger key sizes or ciphertext sizes generally require larger amounts of memory and/or network communication resources than algorithms with smaller key sizes or ciphertext sizes. In another example, the larger the number of bits of security used in an algorithm, the more processing-intensive the algorithm will generally be.

In a cryptographic agility system, an initial stage of selecting a cryptographic technique may involve ensuring that the security requirements for a given cryptographic operation, such as a level of security required by policy and/or context information, are met. However, there may be multiple algorithms and/or configurations of algorithms that meet these requirements. Thus, techniques described herein involve factoring the availability of specialized hardware, operation-related considerations (e.g., which mathematical operations are to be performed in a data aggregation process), resource-related considerations, and/or the like into the determination of which algorithms and/or configurations to use, such as based on information associated with a request and/or based on device and/or network performance metrics and/or capability information.

Cryptographic techniques may be tagged, such as by an administrator or expert, based on whether they involve confidential computing, whether they require particular types of specialized hardware (e.g., a secure enclave), whether they are homomorphic, supported mathematical operations, based on resource requirements, and based on levels of security, threats protected against, and/or the like. For example, a given technique may be tagged with an indication of required hardware, supported mathematical operations (e.g., in the case of homomorphic encryption), and/or with a classification with respect to each of memory requirements, processing requirements, network resource requirements, and/or the like. Classifications may take a variety of forms, such as high, medium, and low, numerical scales (e.g., 0-10), binary indications, and/or the like. In some embodiments, classifications may be imported from one or more sources, such as cryptographic technique providers, open source entities, standards bodies, and/or the like. In some embodiments, rather than individual cryptographic techniques being tagged, types of cryptographic techniques are tagged with attribute such as required hardware, supported mathematical operations and/or classifications relating to various types of resource requirements. In one example, a tag may indicate that all confidential computing techniques require a secure enclave. In another example, a tag may indicate that all “additive” homomorphic encryption algorithms support addition. In another example, a tag may indicate that all fully homomorphic encryption algorithms are associated with a high processing resource requirement. In yet another example, a tag may indicate that all confidential computing techniques are associated with a low processing resource requirement. In still another example, a tag may indicate that all techniques that involve the use of an accelerator are associated with a high processing resource requirement. An accelerator is a hardware device or a software program that enhances the overall performance of a computer, such as by processing data faster than a central processing unit (CPU) of the computer (e.g., which may be referred to as a compute accelerator). It is noted that CPUs may in some cases have special instructions for accelerating cryptographic operations, such as the Advanced Encryption Standard New Instructions (AES-NI) instruction set from Intel®, and a tag may indicate that a cryptographic technique is or is not compatible with such special instructions. Furthermore, cryptographic techniques may be tagged with indications of capability requirements, such as whether an accelerator and/or other specialized hardware is required.

When a cryptographic request is submitted by an application, the cryptographic agility system may gather information associated with the request (e.g., from the request itself, from metadata associated with the request, and/or through communication with one or more other components) related to a privacy-preserving data aggregation process. Furthermore, the cryptographic agility system may gather information related to resource conditions and/or capabilities of the network and/or devices related to the cryptographic request. For instance, the cryptographic agility system may gather current resource availability (e.g., based on capacity and utilization), performance metrics, capability information, and the like for the device and/or network from which the request is received. In one example, the cryptographic agility system determined whether specialized hardware such as a secure enclave required for one or more confidential computing techniques is available. Techniques for gathering such information are known in the art and may involve, for example, including contextual information in the cryptographic request, communication with one or more performance monitoring components, communication with the involved devices, and/or the like.

Thus, the cryptographic agility system may select cryptographic techniques that are best suited to the context which in the privacy-preserving data aggregation process is to be performed. For example, if processing resource availability at a device is low (e.g., if processor utilization is high), then ciphers that meet requisite conditions (e.g., privacy-preserving and/or meeting a given level of security) and yet have low processing requirements may be selected. In another example, if network latency is high (e.g., for a satellite-based network) or if memory availability is low, then ciphers that support the requisite conditions and yet have smaller key sizes or ciphertext sizes may be selected in order to reduce the amount of data that will need to be stored and/or transmitted over the network to implement the cryptographic technique.

In some cases, multiple cryptographic algorithms and/or configurations of algorithms, and/or techniques may be used to service a single cryptographic request. For instance, if a new, more secure cryptographic algorithm has recently become available but is not yet certified by a particular organization, and a particular cryptographic request requires cryptography that is certified by the particular organization, a certified algorithm may first be used and then the new algorithm may be used on top of the certified algorithm to provide the added level of security.

Furthermore, for a privacy-preserving data aggregation process, the multiple endpoints that send encrypted data to an aggregation device (e.g., either using homomorphic encryption or, in the event that confidential computing is to be used as the aggregator device, non-homomorphic encryption) may encrypt local data using a single encryption key that is shared across the endpoints (but not with the aggregation device except, in some cases, the secure enclave) and/or may use different encryption keys, such as using a multi-key encryption scheme (e.g., so that one endpoint is unable to decrypt the local data from another endpoint even if it were to obtain such local data). In some embodiments, attribute based encryption (ABE) techniques may be used in order to provide more fine-grained access control for encrypted data that is sent by endpoints to an aggregation device. For example, ABE techniques may allow multiple private keys to be used with a single public key, such as allowing each endpoint in a data aggregation process to use a distinct private key, while all of the endpoints may use a common public key that is constructed from a list of attributes such that any party that has all of the attributes can decrypt the data.

According to certain embodiments, cryptographic techniques used for a data aggregation process may be centrally selected and/or orchestrated, such as by the aggregator device, one of the endpoints, or another centralized component. For example, the centralized component may invoke generic cryptographic functionality provided by the cryptographic agility system described herein (e.g., a generic cryptography module may be located on the same device as the centralized component or may be otherwise in communication with the centralized component) in order to dynamically select one or more cryptographic techniques for use in a privacy-preserving data aggregation process involving a plurality of endpoints and one or more aggregator devices, such as providing contextual information related to the data aggregation process to the cryptographic agility system. In some cases, the endpoints (and, in some embodiments, the aggregator device) may transmit local contextual information to the centralized component (e.g., securely, such as in encrypted form), and the centralized component may use the contextual information received from the endpoints to provide contextual information to the cryptographic agility system, such as based on a lowest common denominator across the contextual information received from the endpoints or some other aggregation of the contextual information received from the endpoints. The cryptographic agility system may then dynamically select one or more cryptographic techniques for use in the data aggregation (e.g., based on the contextual information as described herein) and provide information about the selected one or more cryptographic techniques to the centralized component. The centralized component may then distribute at least subsets of the information about the one or more selected cryptographic techniques to the endpoints (and, in some embodiments, to the aggregator device) such that the endpoints can use the selected one or more cryptographic techniques to encrypt local data prior to sending such local data to the aggregator device. The endpoints may perform encryption using the selected one or more cryptographic techniques themselves or may interact with one or more other components, such as one or more generic cryptography modules, to perform the encryption. The aggregator device may be provided with instructions (e.g., by the centralized component) indicating whether the aggregator device is to decrypt the received local parameters (e.g., if non-homomorphic encryption is used), to perform aggregation on the encrypted local parameters (e.g., if homomorphic encryption is used), to use a confidential computing component, and/or the like.

As such, embodiments of the present disclosure improve upon conventional cryptography techniques for data aggregation processes in which cryptographic algorithms are pre-determined for applications (e.g., at design time), and in which the aggregator device is given access to the unencrypted data, by providing for the dynamic selection of privacy preserving cryptographic techniques, such as confidential computing and/or homomorphic encryption techniques, that are tailored for the devices and networks involved and/or for the types of operations to be performed, and that may not be natively supported by the applications involved in the data aggregation processes. For example, by selecting targeted confidential computing techniques or homomorphic encryption algorithms and/or configurations based on the available hardware, the operations to be performed, and/or based on network and/or resource constraints, techniques described herein improve the functioning of devices and networks on which cryptographic operations are performed by ensuring that cryptographic operations do not burden devices or networks beyond their capacity or capabilities while preserving the privacy of local data, such as allowing an aggregator device to perform required operations without being granted unrestricted access to the underlying data. As such, the aggregator device does not need to be trusted with data access, and can potentially be located in an untrusted networking environment (e.g., the Internet or a public cloud environment). Additionally, the aggregator device does not need to decrypt the data before performing aggregation functions, except inside the secure enclave in the case of confidential computing, thereby reducing computing resource utilization at the aggregator device, improving security, and/or improving the functioning of the computing system. Furthermore, embodiments of the present disclosure improve information security by ensuring that the most secure and updated cryptographic techniques that are consistent with available hardware, required operations, and/or with device and network constraints may be utilized by an application, even if such techniques were not available at the time the application was developed.

Additionally, techniques described herein may facilitate an organization's use of uniform policy configuration (e.g., a suite of coordinated policies), such as to orchestrate cryptographic usage across many endpoints (e.g., involved in a privacy-preserving data aggregation process). Embodiments of the present disclosure may also be used to facilitate migration to new confidential computing and/or homomorphic encryption algorithms at scale and/or to remove deprecated homomorphic encryption algorithms and/or confidential computing techniques from use in a centralized and coordinated manner.

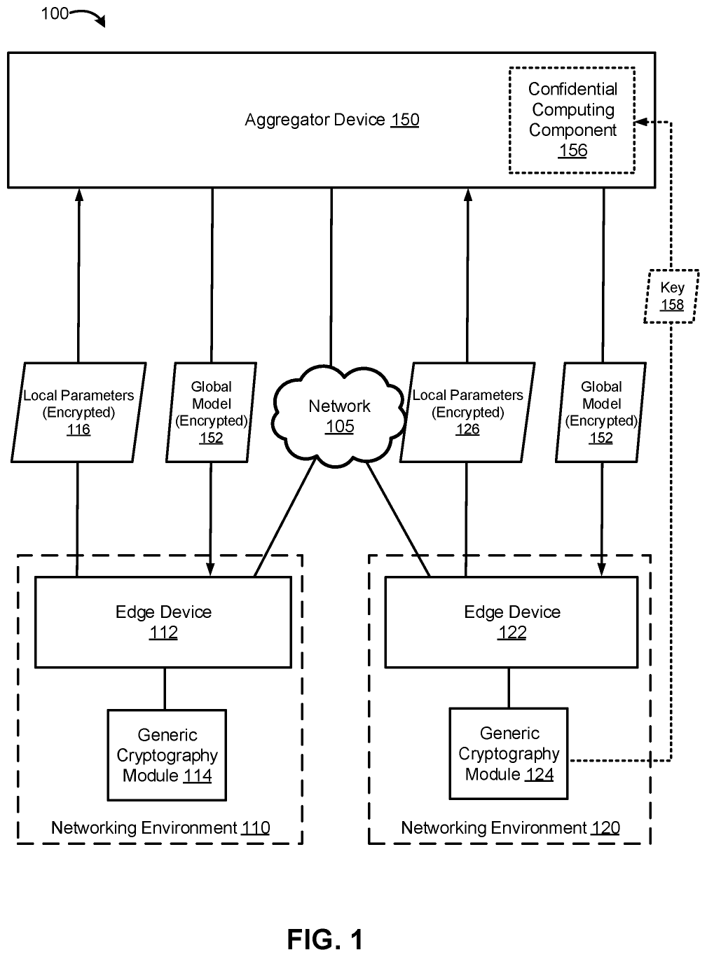

FIG. 1 is an illustration 100 of example computing components related to confidential computing and homomorphic encryption for privacy-preserving data aggregation, according to embodiments of the present disclosure.

An example data aggregation process involves a federated learning process in which multiple endpoints, such as edge devices 112 and 122 in separate networking environments 110 and 120, send local parameters 116 and 126 to an aggregator device 150 for aggregation, and aggregator device 150 sends a global model 152 produced as a result of the aggregation back to the endpoints. It is noted that federated learning does not necessarily involve the creation of a global machine learning model and could also involve the creation of global learned parameters or determinations that are sent back to the endpoints. As such, the term model as used herein is not intended to limit federated learning processes to the creation of machine learning models. Furthermore, other types of data aggregation processes may also be performed with techniques described herein.

Networking environments 110 and 120 may be separate networks, such as data centers (e.g., physical data centers or software defined data centers), cloud environments, local area networks (LANs), and/or the like. In certain embodiments, networking environments 110 and 120 are private networking environments that implement security mechanisms (e.g., firewalls) to prevent unauthorized access. Edge devices 112 and 122 represent physical or virtual devices that provide entry points into networking environments 110 and 120. For example, in some embodiments, communications to and from networking environment 110 are received and/or transmitted via edge device 112 and communications to and from networking environment 120 are received and/or transmitted via edge device 122. Edge devices 112 and 122 communicate with an aggregator device 150 via a network 105, with may be any sort of connection over which data may be transmitted. In certain embodiments, network 105 is a wide area network (WAN) such as the Internet.

Aggregator device 150 generally represents a physical or virtual device that performs aggregation functionality for a federated learning process. Aggregator device 150 may be located, for example, in a public networking environment, such as a public cloud. In one example, aggregator device 150 is a cloud service. In other examples, aggregator device may be located in one of networking environments 110 or 120 and/or may be located in a different private or public networking environment.

Aggregator device 150 optionally includes a confidential computing component 156. For example, confidential computing component 156 may be a secure processor enclave of a processing device. Confidential computing component 156 generally represents a hardware-backed secure environment that shields code and data from observation or modification by any components outside of the secure environment, thus reducing the burden of trust on a computer's operating system or hypervisor while allowing computations to be performed on the data within the secure environment. Confidential computing component 156 may, for example, provide such a secure environment through a partitioning process in which the central processing unit (CPU) places hardware checks on the memory allocated to each component such as a virtual machine (VM) on aggregator device 150 and ensures these boundaries are not crossed, or through a memory encryption process in which the CPU automatically encrypts VM memory with different keys for different VMs. Confidential computing component 156 may also provide such a secure environment through a combination of these techniques, and/or through one or more other techniques.

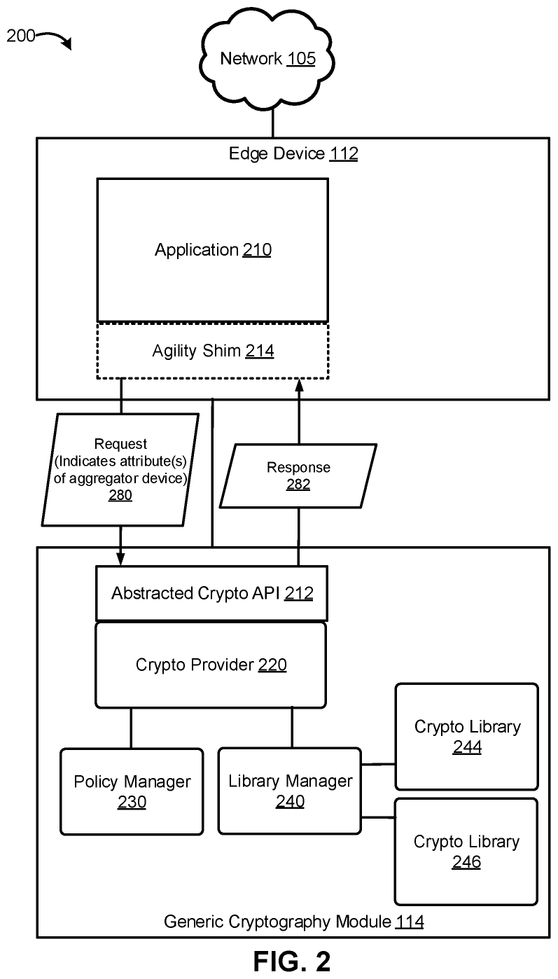

Edge devices 112 and 122 communicate with generic cryptography modules 114 and 124 in order to perform cryptographic functionality related to the federated learning process. As described in more detail below with respect to FIG. 2, generic cryptography modules 114 and 124 may be physical or virtual computing devices, such as server computers or virtual computing instances (VCIs), on which components of a cryptographic agility system reside. For example, generic cryptography modules 114 and 124 generally perform operations related to dynamically selecting cryptographic techniques (e.g., based on contextual information related to requests for cryptographic operations), performing the requested cryptographic operations according to the selected techniques, and providing results of the operations to the requesting components. It is noted that while generic cryptography modules 114 and 124 are shown as separate devices from edge devices 112 and 122 in networking environments 110 and 120, these generic cryptography modules may alternatively be implemented on the same devices as edge devices 112 and/or 122 (e.g., as separate software components).

In an example, edge devices 112 and 122 send requests to generic cryptography modules 114 and 124 to encrypt local data (e.g., local model parameters determined through a local model training process based on local training data), such as indicating that the requests relate to a privacy-preserving data aggregation process, indicating one or more attributes of aggregator device 150, indicating one or more types of mathematical operations to be performed by aggregator device 150, and/or the like in the request. Generic cryptography modules 114 and 124 dynamically select one or more cryptographic techniques such as involving confidential computing or homomorphic encryption algorithms based on attributes associated with the request, such as whether required specialized hardware is available, the operations to be performed, other computing resource and/or capability constraints, policy considerations, and/or the like. In some embodiments, generic cryptography modules 114 and 124 communicate with each other, such as via a secure channel established between them, to coordinate aspects of the one or more selected encryption techniques. In an example, generic cryptography modules 114 and 124 securely share an encryption key that is used at both generic cryptography modules 114 and 124 to encrypt local data. In another example, generic cryptography modules 114 and 124 coordinate a multi-key homomorphic encryption scheme with one another so that a key does not need to be shared between generic cryptography modules 114 and 124. In some embodiments, generic cryptography modules 114 and 124 coordinate with a generic cryptography module associated with aggregator device 150 as well, such as indicating a selected encryption technique.

After dynamically selecting one or more encryption techniques, generic cryptography modules 114 and 124 may encrypt the respective local data using the selected technique(s) and return the respective encrypted local data to edge devices 112 and 122. In alternative embodiments, generic cryptography modules 14 and 124, rather than performing encryption themselves, may provide information to one or more other components, such as edge devices 112 and 122 and/or other encryption components, to perform the selected encryption technique(s).

If the selected technique involves homomorphic encryption, then the encrypted data can be sent to aggregator device 150 without any encryption key being provided to aggregator device 150, and aggregator device 150 can perform computations on the encrypted data without decryption. If the selected technique involves confidential computing, the data will be encrypted using an encryption algorithm (e.g., non-homomorphic) that otherwise complies with requisite factors, and a key 158 may be sent by crypt server 124 via a secure channel directly to confidential computing component 156 so that the encrypted data can be securely unencrypted within confidential computing component 156 using the key 158 and the result of the computations can be encrypted within confidential computing component 156 using the key 158. While not shown, in some embodiments, a key may also be sent from generic cryptography module 114 to confidential computing component 156 in a similar manner.

Edge devices 112 and 122 send the encrypted local parameters 116 and 126 to aggregator device 150, which performs aggregation functionality. For example, in the case of homomorphic encryption, aggregator device 150 may perform one or more mathematical operations, such as addition, subtraction, division, and/or multiplication in order to aggregate encrypted local parameters 116 and 126. In one example, aggregator device 150 calculates an average of encrypted local parameters 116 and 126 by adding encrypted local parameters 116 and 126 and dividing the sum by the total number of edge devices involved in the federated learning process (e.g., which is two in the depicted example). In another example, in the case of confidential computing, aggregator device 150 may provide the encrypted local parameters 116 and 126 to confidential computing component 156, such as along with instructions to perform one or more mathematical operations, such as addition, subtraction, division, and/or multiplication in order to aggregate encrypted local parameters 116 and 126. In such cases, encrypted local parameters 116 and 126 are decrypted within confidential computing component 156 (such that the unencrypted parameters cannot be accessed outside of confidential computing component 156), the computations are performed to produce a result, and the result is encrypted before being sent outside of confidential computing component 156. If encrypted local parameters 116 and 126 were encrypted using different encryption techniques and/or keys (e.g., which may have been separately provided to confidential computing component 156 by generic cryptography module 114 and generic cryptography module 124), then confidential computing component 156 may encrypt the result of the computations with a first key/technique corresponding to generic cryptography module 124 for sending the encrypted result to crypto edge device 112 and also encrypt the result of the computations with a second key/technique corresponding to generic cryptography module 114 for sending the encrypted result to edge device 122. Thus, each endpoint can decrypt the encrypted global model 152. Alternatively, confidential computing component 156 may encrypt the result of the computations using a different encryption technique altogether, and may send one or more encryption keys securely to generic cryptography modules 114 and 124 for use in decrypting encrypted global model 152.

It is noted that in many embodiments the number of participating endpoints (e.g., edge devices) will be larger than two. Furthermore, participating endpoints need not be edge devices, and edge devices are included as an example. Additionally, aggregation is not limited to averaging, and other types of aggregation computations may alternatively be performed. The local parameters that are aggregated to produce global parameters may include, for example, gradients, weights, hyperparameters, and/or the like. Local parameters may include information that is specific to particular participants (e.g., endpoints) in the data aggregation process, and thus may include sensitive information that the participants do not want revealed to the aggregator device (or to the other participants).

The results of computations performed by aggregator device 150 on encrypted local parameters 116 and 126 will remain encrypted, such that aggregator device 150 will not have access to the unencrypted local parameters or the unencrypted global parameters (e.g., outside of confidential computing component 156 in the case of confidential computing). Aggregator device 150 sends an encrypted global model (e.g., produced as a result of the aggregation functionality, such as comprising the encrypted global parameters, which may in one example be the average of the local parameters) to edge devices 112 and 122.

Edge devices 112 and 122 may decrypt the encrypted global model 152 using the key(s) with which encrypted local parameters 116 and 126 were encrypted (or key(s) received from confidential computing component 156) in order to determine the unencrypted global model. For example, edge devices 112 and 122 may send requests to generic cryptography modules 114 and 124 to decrypt the encrypted global model 152, and generic cryptography modules 114 and 124 may perform decryption and return the unencrypted global model to edge devices 112 and 122. In the case of homomorphic encryption, the unencrypted global model will be the same as if the computations performed by aggregator device 150 has been performed on the unencrypted local data from edge devices 112 and 122. In the case of confidential computing, the computations were performed on the unencrypted local data but with a secure environment. Thus, edge devices 112 and 122 are provided with a global model that benefits from the local training performed at all endpoints without being biased by peculiar attributes of local training data from any individual endpoint. Furthermore, the privacy of the local data is preserved, as aggregator device 150 is never granted access to the unencrypted local data or the unencrypted global data (e.g., outside of confidential computing component 156 in the case of confidential computing), and the unencrypted local data is never shared between different endpoints. Additionally, computing resource constraints and capabilities of the computing devices and networks are respected through the dynamic selection of encryption techniques based on such constraints and capabilities, such as selecting one or more confidential computing or homomorphic encryption techniques that are consistent with available hardware, that support the particular mathematical operations that are to be performed by aggregator device 150 (and that comply with one or more additional policies), and/or that also are well-suited to the devices and networks involved in the federated learning process.

It is noted that while certain embodiments are described in which an aggregator device performs aggregation on encrypted data from endpoints and sends results of the aggregation back to the endpoints, other embodiments may involve the aggregation device acting as a sort of middle box that performs aggregation on encrypted data from endpoints and then sends results of the aggregation to one or more different endpoints (e.g., different than the endpoints from which the encrypted data was received). For example, the one or more different endpoints may be provided one or more decryption keys (e.g., used to generate the encrypted data) by the one or more endpoints, and the one or more different endpoints may use the one or more decryption keys to decrypt the results of the aggregation received from the aggregation device.

FIG. 2 is an illustration 200 of an example related to dynamic cryptographic technique selection for privacy-preserving data aggregation, according to embodiments of the present disclosure. Illustration 200 includes network 105, edge device 112, and generic cryptography module 114 of FIG. 1.

Edge device 112 may be a physical or virtual computing device, such as a server computer, that runs an application 210. In some embodiments, edge device 112 may be a virtual computing instance (VCI), such as a virtual machine (VM) or container that runs on a physical host computer that includes one or more processors and/or memory devices. It is noted that edge device 112 is included as an example computing device on which application 210 and/or associated components may be located, and other types of devices may also be used.

Application 210 generally represents a software application that requires cryptographic functionality. For example, application 210 may rely on cryptographic functionality to encrypt data that it transmits over a network (e.g., network 105), such as to aggregator device 150 of FIG. 1. In one example, application 210 performs operations related to federated learning, such as sending local model parameters (e.g., which may have been generated at edge device 112 and/or one or more other devices involved in a local model training process based on local training data) to an aggregator device for aggregation with local parameters from other edge devices. While conventional techniques generally involve direct integration of cryptographic libraries with applications that rely on cryptographic functionality, such as for transmitting data associated with a federated learning process, techniques described herein involve abstracting cryptographic functionality away from such applications. As such, an abstracted crypto application programming interface (API) 212 is provided as a means of interaction between application 210 and a separate cryptographic agility system. Application 210 may call generic cryptographic functions of abstracted crypto API 212 in order to invoke particular cryptographic functionality, and the cryptographic agility system may select cryptographic techniques and perform cryptographic operations in response to the function invocations based on contextual information (e.g., including the hardware capabilities of one or more devices, types of mathematical operations to be performed, resource constraints, and/or the like). Thus, application 210 may be merely a consumer of cryptography provided by the separate cryptographic agility system, rather than implementing cryptography itself.

The cryptographic agility system includes abstracted crypto API 212 and, in certain embodiments, an optional agility shim 214, as well as crypto provider 220, policy manager 230, and library manager 240. In some embodiments, while depicted as separate components, the functionality associated with agility shim 214, abstracted crypto API 212, policy manager 230, and/or library manager 240 may be part of crypto provider 220 and/or may be implemented by more or fewer components. In certain embodiments, abstracted crypto API 212 and/or agility shim 214 are part of application 210. In alternative embodiments, abstracted crypto API 212 and/or agility shim 214 may be located on a separate device from edge device 112, such as on the same device as generic cryptography module 114 or a different computing device.

Agility shim 214 generally intercepts API calls (e.g., calls to functions of abstracted crypto API 212) and redirects them to crypto provider 220 via abstracted crypto API 212. Shims generally allow new software components to be integrated with existing software components by intercepting, modifying, and/or redirecting communications. As such, agility shim 214 allows application 210 to interact with crypto provider 220 even though application 210 may have no knowledge of crypto provider 220. For instance, application 210 may make generic function cryptographic function calls (e.g., requesting that an item of data be encrypted), and these generic function calls may be intercepted by agility shim 214 (e.g., if such a shim is needed) and redirected to crypto provider 220 via the abstracted crypto API 212 exposed by crypto provider 220.

It is noted that while embodiments of the present disclosure are depicted on edge device 112 and generic cryptography module 114, alternative embodiments may involve various components being located on more or fewer computing devices. In some cases, aspects of the cryptographic agility system may be implemented in a distributed fashion across a plurality of computing devices. In certain embodiments, said components may be located on a single computing device.

In certain embodiments, generic cryptography module 114 comprises a physical or virtual computing device, such as a server computer, on which components of the cryptographic agility system, such as crypto provider 220, policy manager 230, and/or library manager 240, reside. For example, generic cryptography module 214 may represent a VCI or a physical computing device. Generic cryptography module 214 may be connected to network 105 and/or one or more additional networks (e.g., networking environment 110 of FIG. 1).

Crypto provider 220 generally performs operations related to dynamically selecting cryptographic techniques (e.g., based on contextual information related to requests for cryptographic operations, such as whether specialized hardware is available, the types of mathematical operations to be performed in a federated learning process, and/or the like), performing the requested cryptographic operations according to the selected techniques, and providing results of the operations to the requesting components. Cryptographic techniques may include the use of confidential computing, cryptographic algorithms (e.g., included in one or more libraries), and/or specific configurations of cryptographic algorithms, as described herein. In some embodiments, the cryptographic agility system is located on the same device as application 210, while in other embodiments the cryptographic agility system is located on a separate device, such as on a server that is accessible over a network.

In certain aspects, crypto provider 220 has two major subsystems, policy manager 230 and library manager 240. Policy manager 230 performs operations related to cryptographic policies, such as receiving policies defined by users and storing information related to the policies, such as in a policy table. According to certain embodiments, a centralized policy control server may orchestrate policy across a plurality of generic cryptography modules, such as including generic cryptography module 114. For example, an administrator or other user may configure one or more policies at a centralized policy control server, and the one or more policies may be distributed to a plurality of generic cryptography modules for storage by corresponding policy managers, such as including policy manager 230. In an example, a policy is based on one or more of an organizational context and a user context related to a cryptographic request. In some embodiments, a policy may map a cryptographic request and its associated context information to attributes of cryptographic techniques, such as a particular cryptographic technique in a particular cryptographic library and a particular set of parameters for configuring the particular cryptographic technique.

Organizational context may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, a policy may indicate that if a cryptographic request is received from a device associated with a particular geographic region, associated with a particular industry, and/or within the jurisdiction of a particular governmental entity, then crypto provider 220 must select a cryptographic technique that meets one or more conditions (e.g., having a particular security rating, being configured to protect against particular types of threats, and/or involving confidential computing or homomorphic encryption) in order to comply with relevant laws, regulations, preferences, or mandates.

User context may involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. For example, a policy may indicate that if a cryptographic request is received from a particular category of user (e.g., administrators, general users, or the like), relating to a particular type of data (e.g., tagged as sensitive or meeting characteristics associated with sensitivity, such as being financial or medical data, or being associated with privacy-preserving data aggregation), associated with a particular application or type of application, associated with a particular platform (e.g., operating system), from a device with particular capabilities or other attributes (e.g., having a certain amount of processing or memory resources, having an accelerator, having one or more particular types of processors, and/or the like), from a device in a particular location (e.g., geographic location) or type of networking environment (e.g., cellular network, satellite-based network, land network, or the like), and/or that is to be transmitted to a device having one or more particular characteristics (e.g., being untrusted, being located in a public networking environment, being located in a particular geographic region, having specialized hardware, and/or the like), then crypto provider 220 should select a cryptographic technique that meets one or more conditions.

In one example, a policy indicates that if a request relates to encrypting data that is to be transmitted to a device that is untrusted for one or more reasons for computation to be performed on the data, then a confidential computing or homomorphic encryption technique should be selected. One example policy states that confidential computing should be selected rather than homomorphic encryption whenever the required specialized hardware (e.g., secure enclave) is available. In certain embodiments, a policy may specify that, unless otherwise required (e.g., because of another policy, such as related to security level), when homomorphic encryption is used, a homomorphic encryption technique that supports the required mathematical operations while having the lowest resource utilization requirements of all such homomorphic encryption techniques is to be selected. In certain embodiments, a policy may simply specify an allowed list of ciphers or an allowed list of cryptographic technique characteristics. In some cases, a policy may relate to resource constraints (e.g., based on available processing, memory, network, physical storage, accelerator, entropy source, or battery resources), such as specifying that cryptographic techniques must be selected based on resource availability (e.g., how much of a device's processing and/or memory resources are currently utilized, how much latency is present on a network, and the like) and/or capabilities (e.g., whether a device is associated with an accelerator) associated with devices and/or networks, while in other embodiments crypto provider 220 selects cryptographic techniques based on resource constraints and/or supported mathematical operations independently of policy manager 230 (e.g., for all applicable cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies. In one example, once all cryptographic techniques meeting the security requirements, hardware requirements, and/or mathematical operation requirements for a cryptographic request are identified (e.g., based on policies or otherwise), a cryptographic technique is selected from these compliant cryptographic techniques based on resource constraints.

It is noted that resource constraints and/or capabilities may include a variety of different types of information, such as processor availability and/or capabilities (e.g., clock rate, number of cores, instruction-level features such as single instruction multiple data (SIMD) instructions, types of processors, inclusion of secure enclaves, and/or the like) memory availability and/or capabilities (e.g., memory size and performance), accelerator capabilities (e.g., hardware-based cryptographic accelerator units available for use with the device), battery capabilities (e.g., lifetime, current power remaining, and/or the like), information about entropy (e.g., how much entropy is available for random numbers, the source of entropy such as an OS, hardware module, CPU platform, or the like, whether available entropy sources are federal information processing standards (FIPS) compliant, and/or the like), network connectivity information (e.g., bandwidth, loss metrics for the channel, congestion, latency, and/or the like), information about the device's physical exposure to potential side-channel attacks and/or ease of side channel analysis, and/or the like. Thus, any of these types of data points may be gathered from devices and/or networks, and may be used in selecting cryptographic techniques (e.g., based on policies and/or tags related to these data points associated with cryptographic techniques).

A policy table may store information related to policies. In some embodiments, a policy table maps various contextual conditions (e.g., relating to organizational context and/or user context) to cryptographic technique characteristics (e.g., whether techniques are privacy-preserving, homomorphic, involve confidential computing, require specialized hardware, support certain mathematical operations, have certain security ratings, protect against certain threats, have certain resource utilization ratings, and the like). For example, a contextual condition may be the use of a certain type of application, the requirement that privacy be preserved during computation, the requirement of certain mathematical operations to be performed on encrypted data, a certain type of data, or a particular geographic location. A cryptographic technique characteristic may be, for example, whether the cryptographic technique is homomorphic, whether the cryptographic technique involves confidential computing and/or requires certain specialized hardware, supported mathematical operations, a security rating (e.g., 0-10), whether the cryptographic technique is quantum-safe, what level of resource requirements the cryptographic technique has for a particular type of resource (e.g., memory, processor, or network resources), or the like. Thus, when cryptographic requests are received, a policy table may be used to determine whether the cryptographic requests are associated with any characteristics included in policies and, if so, what cryptographic technique characteristics are required by the policies for servicing the requests.

Library manager 240 generally manages cryptographic libraries containing cryptographic algorithms and/or techniques. For example crypto libraries 244 and 246 each include various cryptographic algorithms, each of which may include configurable parameters, such as key size, choice of elliptic curve, algorithm sizing parameters, and the like, and characteristics such as ciphertext size. For instance, cryptographic techniques (e.g., algorithms and/or specific configurations of algorithms, and/or confidential computing techniques) may be registered with library manager 240 along with information indicating characteristics of the cryptographic techniques. Examples of algorithms include the Paillier cryptosystem, the Boneh-Goh-Nissim cryptosystem, the Rivest-Shamir-Adleman (RSA) cryptosystem, the Gentry cryptosystem(s), the Brakerski-Gentry-Vaikuntanathan (BGV) cryptosystem(s), the Cheon, Kim, Kim and Song (CKKS) cyrptosystem(s), the Clear and McGoldrick multi-key homomorphic cryptosystem, data encryption standard (DES), triple DES, advanced encryption standard (AES), Diffie-Hellman (DH) encryption, Elliptic Curve DH (ECDH) encryption, digital signatures such as Digital Signature Algorithm (DSA) and Elliptic Curve DSA (ECDSA), cryptographic hash functions such as Secure Hash Algorithm 2 or 3 (SHA-2 or SHA-3), and others. There are many other types of encryption algorithms, including homomorphic and non-homomorphic encryption algorithms, and the algorithms listed herein are included as examples. Some algorithms may, for example, involve symmetric key encryption or asymmetric key encryption, digital signatures or cryptographic hash functions, and/or the like. A configuration of an algorithm may include values for one or more configurable parameters of the algorithm, such as key size, size of lattice, which elliptic curve is utilized, number of bits of security, whether accelerators are used, ciphertext size, and/or the like. Cryptographic techniques may also involve confidential computing techniques, which may rely on the use of specialized hardware, such as Intel® Software Guard Extensions (SGX), Project Amber, Intel® Trust Domain Extensions (TDX), Arm® TrustZone®, and/or the like. A characteristic of a cryptographic technique may be, for example, whether the cryptographic technique is privacy-preserving, whether the cryptographic technique involves confidential computing, whether the cryptographic technique is homomorphic, what types of specialized hardware are required for the cryptographic technique, supported mathematical operations, whether the technique is Turing complete (e.g., supports all types of mathematical operations, such as a fully homomorphic encryption scheme), a security rating, a resource requirement rating, whether the technique requires an accelerator, whether the technique is quantum-safe, or the like. A cryptographic technique may include more than one cryptographic algorithm and/or configuration. For example, one cryptographic technique may involve a confidential computing technique in conjunction with an encryption algorithm that is to be used for encrypting data for transmission to the confidential computing component and for encrypting the result of computations performed by the confidential computing component. In an example, each cryptographic technique is tagged (e.g., by an administrator) based on characteristics of the technique, such as with an indication of whether the cryptographic technique is privacy-preserving, whether the cryptographic technique involves confidential computing, whether the cryptographic technique is homomorphic, what types of specialized hardware are required for the cryptographic technique, an indication of supported mathematical operations, a security rating, an indication of threats protected against by the technique, indications of the resource requirements of the technique, and/or the like.

Information related to cryptographic techniques registered with library manager 240 may be stored in an available algorithm/configuration table. For instance, an available algorithm/configuration table may store identifying information of each available cryptographic technique (e.g., an identifier of a library, an identifier of an algorithm or technique in the library, and/or one or more configuration values for the algorithm) associated with tags indicating characteristics of the technique. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “homomorphic encryption algorithms configured to support addition.” Thus, if tags are associated with this type (e.g., including supported mathematical operations, security ratings, recourse requirement ratings, and the like), any specific cryptographic techniques of this type (being homomorphic encryption algorithms, and being configured to support addition) will be considered to be associated with these tags. In another example, fuzzy logic and/or machine learning techniques may be employed, such as based on historical cryptographic data indicating which cryptographic techniques were utilized for cryptographic requests having particular characteristics. In some embodiments, tags may be associated with specific configurations of cryptographic algorithms, such as assigning a security rating to a particular set of configuration parameters for a particular cryptographic algorithm or type of algorithm.

Tags associated with cryptographic techniques may be updated as appropriate over time, such as based on input from a user (e.g., an administrator, security operations professional, and/or the like). For example, a user may provide input upgrading or downgrading a security rating for a particular cryptographic technique, type of cryptographic technique, or configuration of a cryptographic technique (e.g., from 10 out of 10 to 8 out of 10), such as based on changed understandings of vulnerabilities or strengths of particular techniques.

By allowing cryptographic techniques and libraries, including new confidential computing and/or homomorphic encryption techniques that may become available due to the ongoing research into such techniques, to be registered and deregistered with library manager 240 on an ongoing basis, and to be associated with metadata such as tags that can be dynamically updated, embodiments of the present disclosure allow the pool of possible cryptographic techniques to be continuously updated to meet new conditions and threats. For example, as new libraries and/or techniques are developed, these libraries and/or techniques may be added to library manager 240, and such cryptographic techniques may be used by crypto provider 220 in servicing requests from application 210 without application 210 having any awareness of the new libraries and/or techniques. Similarly, by managing policies and libraries separately, policies may be defined in an abstract manner (e.g., based on characteristics of requests and cryptographic techniques) such that policies may be satisfied through the selection of new cryptographic techniques that were not known at the time of policy creation.

In one particular example, a first new cryptographic technique is tagged as being fully homomorphic (e.g., Turing complete), meaning that the cryptographic technique was developed to support all types of mathematical operations in a homomorphic manner. For instance, the first new cryptographic technique may have a high security rating (e.g., 10 out of 10) as well as high resource requirements. The first new cryptographic technique is registered with library manager 240, and information about the first new cryptographic technique and its characteristics is stored in an available algorithm/configuration table. Furthermore, a second new cryptographic technique may be tagged as involving confidential computing and requiring a particular type of specialized hardware. For instance, the second new cryptographic technique may have a low security rating (e.g., 10 out of 10) with low resource requirements. The second new cryptographic technique is registered with library manager 240, and information about the second new cryptographic technique and its characteristics is stored in an available algorithm/configuration table. Thus, the first and second new cryptographic techniques are available to be selected by crypto provider 220 for servicing cryptographic requests from application 210.

Continuing with the example, a policy states that cryptographic requests relating to data that is to be sent to an aggregator device for aggregation as part of a privacy-preserving data aggregation process are to be handled using confidential computing if the required hardware is available and, if the requires hardware is not available, to be handled using fully homomorphic technique if such a technique is available, unless device and/or network resource constraints prohibit the use of such a technique. Thus, when application 210 submits a cryptographic request 280 (e.g., via a call to a generic cryptographic function provided by abstracted crypto API 212) to encrypt an item of data that is to be sent to an aggregator device for aggregation as part of a federated learning process, crypto provider 220 determines based on information stored in the policy table that a confidential computing technique is to be used if possible, or otherwise that a fully homomorphic cryptographic technique is to be used if possible. Crypto provider 220 determines based on information in the available algorithm/configuration table that the second new cryptographic technique involves confidential computing and requires certain specialized hardware. Next, crypto provider 220 analyzes device capabilities related to the cryptographic request 280 to determine if the second new cryptographic technique can be performed. If the required specialized hardware is available, then crypto provider 220 may select the second new cryptographic technique, and provides a response 282 to application 210 (e.g., via agility shim 214) accordingly. Otherwise, crypto provider 220 moves on to consider fully homomorphic techniques. Crypto provider 220 determines based on information in the available algorithm/configuration table that the first new cryptographic technique is fully homomorphic. Next, crypto provider 220 analyzes resource constraints related to the cryptographic request 280 to determine if the first new cryptographic technique can be performed. If crypto provider 220 determines that the device and/or network associated with application 210 can support the first new cryptographic technique (e.g., based on available resources), then crypto provider 220 selects the first new cryptographic technique for servicing the cryptographic request 280, and provides a response 282 to application 210 (e.g., via agility shim 214) accordingly. However, if crypto provider 220 determines that the device and/or network associated with application 210 cannot support the first new cryptographic technique (e.g., based on available resources), then crypto provider 220 selects a different cryptographic technique for servicing the cryptographic request 280, such as a different homomorphic encryption technique that supports the mathematical operations indicated in request 280 and that otherwise complies with the resource constraints of the device and/or network, and provides a response 282 to application 210 (e.g., via agility shim 214) accordingly.

In some cases, the response sent from crypto provider 220 to application 210 includes data encrypted using the selected technique. In other cases, the response includes information related to performing the selected technique to encrypt the data, and the encryption is performed on the device from which the request was sent. In still other cases, one or more other components and/or devices may be involved in performing the encryption according to the technique selected by crypto provider 220.

In some cases, more than one cryptographic technique may be selected for servicing a given cryptographic request. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations). For example, a dual or multi-encryption scheme such as composite encryption or hybrid encryption may be employed for servicing a single cryptographic request. In some embodiments, one or more homomorphic encryption techniques and one or more confidential computing techniques may be selected to service a single cryptographic request.

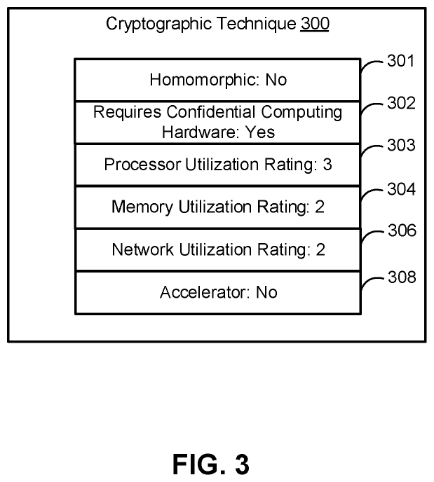

FIG. 3 depicts an example of tagging cryptographic techniques based on attributes, including tagging confidential computing and/or homomorphic encryption techniques with relevant attributes.

A cryptographic technique 300 comprises one or more cryptographic algorithms and/or configurations of algorithms, and/or techniques. For instance cryptographic technique 300 may be included in a cryptographic library, and may be registered with library manager 240 of FIG. 2 as an available cryptographic technique for use in a cryptographic agility system.

Tags 301, 302, 303, 304, 306, and 308 are associated with cryptographic technique 300 to indicate characteristics of cryptographic technique 300. For example, these tags may be added by an administrator at the time cryptographic technique 300 is registered with library manager 240 of FIG. 2. While not depicted, cryptographic technique 300 may also be associated with other tags related to, for example, a security level of cryptographic technique 300, threats protected against by cryptographic technique 300, whether cryptographic technique 300 is quantum-safe, whether cryptographic technique 300 is privacy-preserving, which particular types of specialized hardware are required, which types mathematical operations are supported (e.g., for homomorphic encryption), how many times those types of mathematical operations can be performed (e.g., while maintaining homomorphic properties), and/or the like.

Tags 301, 302, 303, 304, 306, and 308 may be based on a variety of characteristics of cryptographic technique 300, such as the nature of involved cryptographic technique(s), key size, size of lattice, which elliptic curve is utilized, number of bits of security, whether accelerators are used, ciphertext size, whether side channel attacks are protected against (e.g., resulting in higher resource usage), and/or the like.

Tag 301 indicates that cryptographic technique 300 is not a homomorphic encryption technique.

Tag 302 indicates that cryptographic technique 300 requires confidential computing hardware. In some embodiments, a tag may specify the precise hardware or category of hardware required. In one example, cryptographic technique 300 involves the use of any available confidential computing technique and a particular encryption algorithm for transmitting data to and/or from the confidential computing component. In some embodiments, confidential computing techniques and associated encryption algorithms are selected from pre-combined sets, while in other embodiments confidential computing techniques and associated encryption algorithms are selected independently of one another in response to a given request.

Tag 303 indicates a processor utilization rating of 3. In an example, processor utilization ratings may range from 0-10, and generally indicate an amount of processing resources required by a cryptographic technique.

Tag 304 indicates a memory utilization rating of 2. In an example, memory utilization ratings may range from 0-10, and generally indicate an amount of memory resources required by a cryptographic technique.

Tag 306 indicates a network utilization rating of 2. In an example, network utilization ratings may range from 0-10, and generally indicate an amount of network resources required by a cryptographic technique.

Tag 308 indicates that an accelerator is not used by cryptographic technique 300.

Tags 301, 302, 303, 304, 306, and 308 are included as examples, and other types of tags may be included. Tags 301, 302, 303, 304, 306, and 308 generally allow a cryptographic agility system to identify which cryptographic techniques are best suited for a given cryptographic request, such as related to a data aggregation process, based on various characteristics.

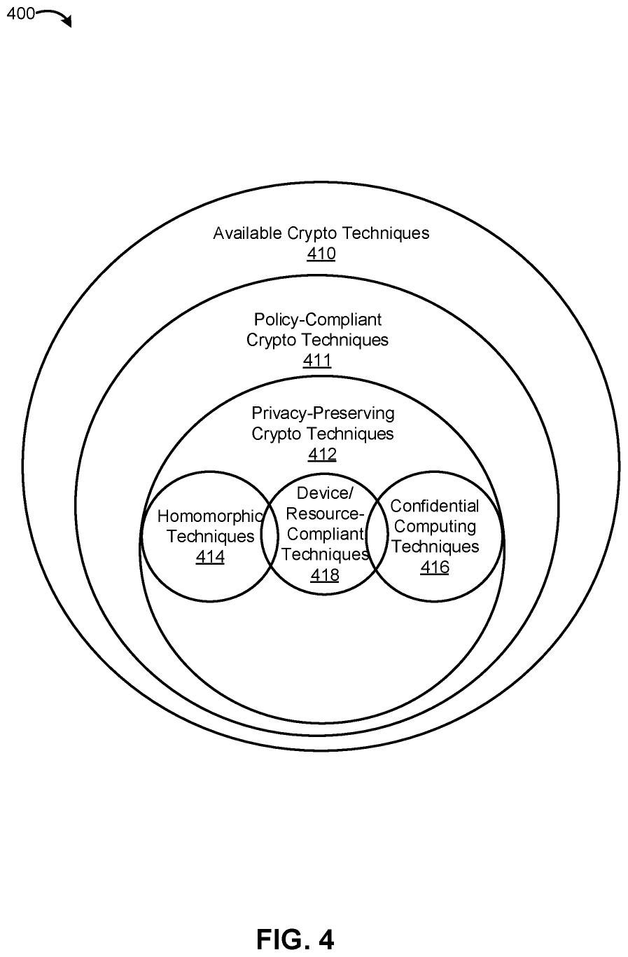

FIG. 4 is a diagram 400 depicting an example related to dynamic cryptographic technique selection for privacy-preserving data aggregation.

Diagram 400 depicts a set of available crypto techniques 410. Available crypto techniques 410 includes all cryptographic techniques that have been registered with a cryptographic agility system, as described above with respect to FIGS. 1-3.

Within the set of available crypto techniques 410 is a subset including policy-compliant crypto techniques 411. Policy-compliant crypto techniques 411 generally includes all available cryptographic techniques that comply with applicable policies for servicing a given cryptographic request. For example, policy-compliant crypto techniques 411 may include all techniques within available crypto techniques 410 that meet a minimum security rating required by a policy, such as based on contextual information associated with the given cryptographic request.

Within the set of policy-compliant crypto techniques 411 is a subset including privacy-preserving crypto techniques 412. For example, if the given cryptographic request relates to a privacy-preserving data aggregation process, privacy-preserving crypto techniques 412 may be required, and may include all confidential computing techniques 416 and homomorphic encryption techniques 414 within policy-compliant techniques 411.

Within the set of privacy-preserving crypto techniques 412 is a subset including device/resource-compliant crypto techniques 418. Device/resource-compliant crypto techniques 418 generally include all techniques within confidential computing techniques 416 and homomorphic encryption techniques 414 that correspond to available hardware (e.g., which may or may not include a secure enclave) and are consistent with resource constraints related to the given cryptographic request. For instance, device/resource-compliant crypto techniques 418 may include any techniques within confidential computing techniques 416 that could be performed using available hardware and resources, and all techniques within homomorphic encryption techniques 414 that can be performed given the applicable resource constraints of involved devices and/or networks.

A cryptographic technique may be selected for servicing the given cryptographic request from device/resource-compliant crypto techniques 418. For instance, the most secure technique and/or the most resource-efficient technique in device/resource-compliant crypto techniques 418 may be selected. In some cases, one or more policies may govern which technique is selected. For example, a policy may state that if device/resource-compliant crypto techniques 418 includes at least one confidential computing technique 416, then such a technique is to be selected. In an alternative example, a policy may state that if device/resource-compliant crypto techniques 418 includes at least one homomorphic technique 414, then such a technique is to be selected. Various other factors may also be involved in the selection process, such as geographic region, organization, locality, and/or the like. Furthermore, when selecting a homomorphic technique 414, the mathematical operations to be performed during the privacy-preserving data aggregation process may also be considered as a factor.

Diagram 400 demonstrates an example hierarchy of compliance with policies, privacy-preserving requirements, device constraints, and resource constraints. In other embodiments, one or more policies may relate to privacy-preservation, device, operation, and/or resource constraints, and so compliance with policies may imply compliance with privacy-preservation, device, operation, and/or resource constraints. Furthermore, the example hierarchy of compliance is included as an example, and other hierarchies are possible. Additionally, there may be cases where there is no available cryptographic technique that complies with all policies, privacy-preservation constraints, device constraints, resource constraints, and operation constraints and so trade-offs may be made (e.g., in accordance with policies and/or logic governing such cases), such as selecting a cryptographic technique that is not fully compliant with one or more of these factors (e.g., if certain factors are non-mandatory), or certain cryptographic requests may be declined as impossible under the circumstances.

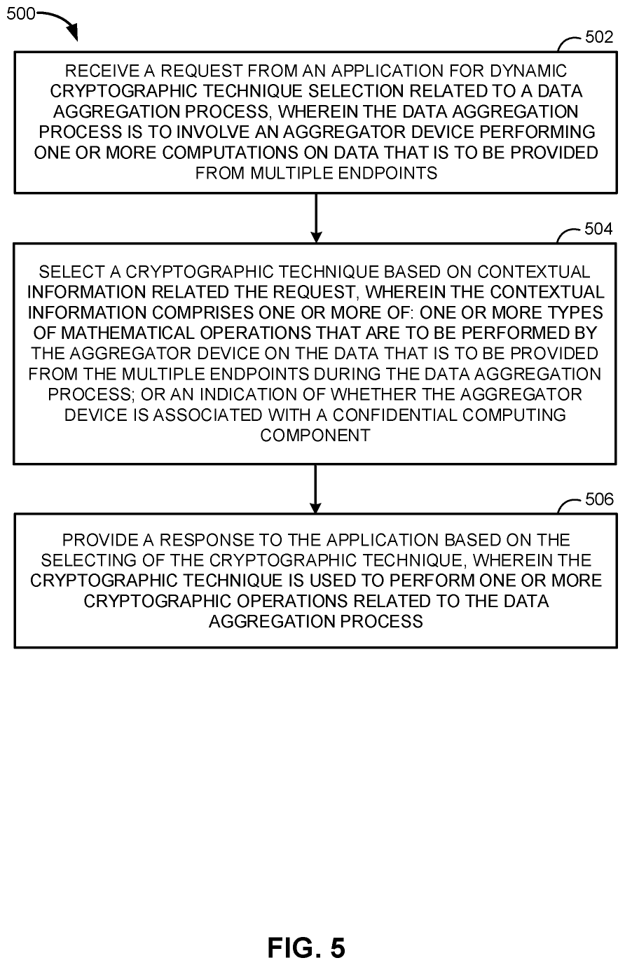

FIG. 5 depicts example operations 500 for dynamic cryptographic technique selection for privacy-preserving data aggregation according to embodiments of the present disclosure. For example, operations 500 may be performed by one or more components of the cryptographic agility system described above with respect to FIGS. 1-4.

Operations 500 begin at step 502, with receiving a request from an application for dynamic cryptographic technique selection related to a data aggregation process, wherein the data aggregation process is to involve an aggregator device performing one or more computations on data that is to be provided from multiple endpoints. It is noted that the aggregator device may be a centralized aggregator device to which a plurality of endpoints (e.g., including the application) are to send data for aggregation or a decentralized data aggregation process may be employed in which the aggregator device is one of the endpoints participating in the data aggregation process and performs aggregation on its local data along with data received from one or more other endpoints (e.g., including the application) participating in such a decentralized data aggregation process.

Furthermore, it is noted that “the application” may refer to one of the endpoints of the data aggregation process, or may refer to a centralized component that orchestrates cryptography across the multiple endpoints for the data aggregation process and may not necessarily be one of the endpoints. In one embodiment, the application is the aggregator device or runs on the aggregator device.

The data aggregation process may be, for example, a federated learning process or a different data aggregation process, such as one in which a result of the aggregation is not provided to the plurality of endpoints (e.g., industrial information aggregation).

Operations 500 continue at step 504, with selecting a cryptographic technique based on contextual information related the request, wherein the contextual information comprises one or more of: one or more types of mathematical operations that are to be performed by the aggregator device on the data that is to be provided from the multiple endpoints during the data aggregation process; or an indication of whether the aggregator device is associated with a confidential computing component.

Operations 500 continue at step 506, with providing a response to the application based on the selecting of the cryptographic technique, wherein the cryptographic technique is used to perform one or more cryptographic operations related to the data aggregation process.

In certain embodiments, performing the one or more cryptographic operations comprises: encrypting given data using a homomorphic encryption technique; or encrypting the given data using a non-homomorphic encryption technique if a confidential computing technique is selected as the cryptographic technique for servicing the request.

In one embodiment, the confidential computing technique is selected as the cryptographic technique for servicing the request, and the operations further comprise sending a decryption key related to the non-homomorphic encryption technique to the confidential computing component associated with the aggregation device via a secure channel. In an example, the confidential computing component comprises a secure enclave.

In some embodiments, an endpoint of the multiple endpoints transmits encrypted data to the aggregator device based on the response, wherein the aggregator device utilizes the confidential computing component to perform the computations on the encrypted data and on corresponding encrypted data from one or more additional endpoints of the multiple endpoints, and wherein an unencrypted version of the encrypted data is not accessible by the aggregator device outside of the confidential computing component.

In certain embodiments, the confidential computing component returns an encrypted result of performing the computations, wherein the aggregator device transmits the encrypted result of performing the computations to the endpoint, and wherein the endpoint obtains an unencrypted version of the encrypted result based on the non-homomorphic encryption technique.

In some embodiments, selecting the cryptographic technique is further based on one or more resource constraints of a device associated with the request. Certain embodiments further comprise determining not to select a fully homomorphic encryption algorithm as the encryption technique based on the one or more resource constraints of the device associated with the request.

In some embodiments, a homomorphic encryption technique is selected as the cryptographic technique for servicing the request, the aggregator device sends an endpoint of the multiple endpoints a result of performing the computations, and the endpoint obtains a decrypted version of the result based on an encryption key associated with homomorphic encryption technique.

In certain embodiments, selecting the cryptographic technique is based on one or more policies relating to cryptographic technique selection. For example, some embodiments further comprise receiving the one or more policies from a policy control server.

In certain embodiments, selecting the cryptographic technique is further based on one or more of: a network constraint; an application characteristic; a user characteristic; a data privacy classification level; or a compliance requirement.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of cryptographic agility for privacy-preserving data aggregation, comprising:
receiving a request from an application for dynamic cryptographic technique selection related to a data aggregation process, wherein the data aggregation process is to involve an aggregator device performing one or more computations on data that is to be provided from multiple endpoints;
selecting a cryptographic technique based on contextual information related the request, wherein the contextual information comprises one or more of:
one or more types of mathematical operations that are to be performed by the aggregator device on the data that is to be provided from the multiple endpoints during the data aggregation process; or
an indication of whether the aggregator device is associated with a confidential computing component; and
providing a response to the application based on the selecting of the cryptographic technique, wherein the cryptographic technique is used to perform one or more cryptographic operations related to the data aggregation process.

2. The method of claim 1, wherein performing the one or more cryptographic operations comprises:
encrypting given data using a homomorphic encryption technique; or
encrypting the given data using a non-homomorphic encryption technique if a confidential computing technique is selected as the cryptographic technique for servicing the request.

3. The method of claim 2, wherein the confidential computing technique is selected as the cryptographic technique for servicing the request, and wherein the method further comprises sending a decryption key related to the non-homomorphic encryption technique to the confidential computing component associated with the aggregator device via a secure channel.

4. The method of claim 3, wherein an endpoint of the multiple endpoints transmits encrypted data to the aggregator device based on the response, wherein the aggregator device utilizes the confidential computing component to perform the computations on the encrypted data and on corresponding encrypted data from one or more additional endpoints of the multiple endpoints, and wherein an unencrypted version of the encrypted data is not accessible by the aggregator device outside of the confidential computing component.

5. The method of claim 4, wherein the confidential computing component returns an encrypted result of performing the computations, wherein the aggregator device transmits the encrypted result of performing the computations to the endpoint, and wherein the endpoint obtains an unencrypted version of the encrypted result based on the non-homomorphic encryption technique.

6. The method of claim 4, wherein the confidential computing component comprises a secure enclave.

7. The method of claim 1, wherein selecting the cryptographic technique is further based on one or more resource constraints of a device associated with the request.

8. The method of claim 7, further comprising determining not to select a fully homomorphic encryption algorithm as the cryptographic technique based on the one or more resource constraints of the device associated with the request.

9. The method of claim 1, wherein a homomorphic encryption technique is selected as the cryptographic technique for servicing the request, wherein the aggregator device sends an endpoint of the multiple endpoints a result of performing the computations, and wherein the endpoint obtains a decrypted version of the result based on an encryption key associated with homomorphic encryption technique.

10. The method of claim 1, wherein selecting the cryptographic technique is based on one or more policies relating to cryptographic technique selection.

11. The method of claim 10, further comprising receiving the one or more policies from a policy control server.

12. The method of claim 1, wherein selecting the cryptographic technique is further based on one or more of:
a network constraint;
an application characteristic;
a user characteristic;
a data privacy classification level; or
a compliance requirement.

13. A system for cryptographic agility for privacy-preserving data aggregation, comprising:
at least one memory; and
at least one processor coupled to the at least one memory, the at least one processor and the at least one memory configured to:
receive a request from an application for dynamic cryptographic technique selection related to a data aggregation process, wherein the data aggregation process is to involve an aggregator device performing one or more computations on data that is to be provided from multiple endpoints;
select a cryptographic technique based on contextual information related the request, wherein the contextual information comprises one or more of:
one or more types of mathematical operations that are to be performed by the aggregator device on the data that is to be provided from the multiple endpoints during the data aggregation process; or
an indication of whether the aggregator device is associated with a confidential computing component; and
provide a response to the application based on the selecting of the cryptographic technique, wherein the cryptographic technique is used to perform one or more cryptographic operations related to the data aggregation process.

14. The system of claim 13, wherein performing the one or more cryptographic operations comprises:
encrypting given data using a homomorphic encryption technique; or
encrypting the given data using a non-homomorphic encryption technique if a confidential computing technique is selected as the cryptographic technique for servicing the request.

15. The system of claim 14, wherein the confidential computing technique is selected as the cryptographic technique for servicing the request, and wherein the at least one processor and the at least one memory are further configured to send a decryption key related to the non-homomorphic encryption technique to the confidential computing component associated with the aggregator device via a secure channel.

16. The system of claim 15, wherein an endpoint of the multiple endpoints transmits encrypted data to the aggregator device based on the response, wherein the aggregator device utilizes the confidential computing component to perform the computations on the encrypted data and on corresponding encrypted data from one or more additional endpoints of the multiple endpoints, and wherein an unencrypted version of the encrypted data is not accessible by the aggregator device outside of the confidential computing component.

17. The system of claim 16, wherein the confidential computing component returns an encrypted result of performing the computations, wherein the aggregator device transmits the encrypted result of performing the computations to the endpoint, and wherein the endpoint obtains an unencrypted version of the encrypted result based on the non-homomorphic encryption technique.

18. The system of claim 16, wherein the confidential computing component comprises a secure enclave.

19. The system of claim 13, wherein selecting the cryptographic technique is further based on one or more resource constraints of a device associated with the request.

20. A non-transitory computer readable medium storing instructions that, when executed by one or more processors, cause the one or more processors to:
receive a request from an application for dynamic cryptographic technique selection related to a data aggregation process, wherein the data aggregation process is to involve an aggregator device performing one or more computations on data that is to be provided from multiple endpoints;
select a cryptographic technique based on contextual information related the request, wherein the contextual information comprises one or more of:
one or more types of mathematical operations that are to be performed by the aggregator device on the data that is to be provided from the multiple endpoints during the data aggregation process; or
an indication of whether the aggregator device is associated with a confidential computing component; and
provide a response to the application based on the selecting of the cryptographic technique, wherein the cryptographic technique is used to perform one or more cryptographic operations related to the data aggregation process.
